(19) United States
(12) Patent Application Publication
(10) Pub. No.: US 2009/0104481 A1
(43) Pub. Date: Apr. 23, 2009

(54) Methods and devices for hydrogen generation

(76) Inventors: Richard M. Mohring, East Brunswick, NJ (US); Reynald Cantave, Brdgewater, MA (US); Keith A. Fennimore, Columbus, NJ (US); Kevin W. McNamara, Red Bank, NJ (US)

Correspondence Address: DICKSTEIN SHAPIRO LLP, 1825 EYE STREET NW, Washington, DC, 20006-5403, US

(21) Appl. No.: 11/907,931

(22) Filed: Oct. 18, 2007

(51) Int. Cl. H01M 8/18; H01M 8/04

(52) U.S. Cl. 429/17; 429/19; 429/20

(57) ABSTRACT

Systems and methods for hydrogen generation based on the hydrolysis of a solid fuel are disclosed. The hydrogen generator comprises a fuel chamber for storing a solid chemical hydride, a chamber for storing a liquid reagent, and a liquid distributor disposed within the fuel chamber. The contact between the solid chemical hydride and the liquid reagent produces a substantially fluid nongaseous product and hydrogen gas. The liquid distributor is configured to move through at least a portion of the substantially fluid nongaseous product within the fuel chamber.

### FIELD OF THE INVENTION

The present invention relates to the generation of hydrogen from a fuel that is stored in solid form and from which hydrogen is generated using a liquid reagent.

### BACKGROUND OF THE INVENTION

Hydrogen is the fuel of choice for fuel cells. Widespread use of fuel cells is dependent on finding a convenient hydrogen source due to the difficulties in storing hydrogen gas. Many hydrogen carriers, including hydrocarbons, metal hydrides, and chemical hydrides are being considered as hydrogen storage and supply systems. In each case, systems need to be developed to release the hydrogen from its carrier, either by reformation as in the case of hydrocarbons, desorption from metal hydrides, or hydrolysis of chemical hydrides.

Complex chemical hydrides, such as sodium borohydride and lithium borohydride, have been investigated as hydrogen storage media with high gravimetric hydrogen storage densities. Sodium borohydride has garnered particular interest, because it can be dissolved in alkaline water solutions with virtually no reaction—hydrogen is not generated until the solution contacts a catalyst to promote hydrolysis. In a typical heterogeneous catalyzed system, the stoichiometric reaction of borohydrides with water to produce hydrogen gas and a borate is illustrated by the following chemical reaction for alkali metal borohydride compounds:

MBH₄+4H₂O→MBO₂.2H₂O+4H₂+heat (1)

To maintain the borohydride and borate solids in solution, water in excess of that required for the stoichiometric hydrolysis reaction is typically stored, since water generally reacts with the borate products to form hydrated borate compounds. Extra water may be added to the system to compensate for this loss, such as by using a dilute borohydride fuel solution, which limits the effective hydrogen storage density of such hydrogen generation systems.

It is desirable to have a hydrogen generator that maximizes the hydrogen stored within a given volume. Such generators offer the potential of compact and safe hydrogen storage that, when coupled with a fuel cell, can provide systems to meet the growing demand for portable power.

### BRIEF SUMMARY OF THE INVENTION

The present invention provides systems and methods for hydrogen generation by the hydrolysis of a solid fuel, and methods of operating a power module. The system includes a reaction chamber adapted to contain at least one solid fuel capable of generating hydrogen upon contact with a liquid reagent, and a liquid distributor for contacting the solid fuel with the liquid reagent in the reaction chamber to produce hydrogen gas and a substantially fluid nongaseous product.

### BRIEF DESCRIPTION OF THE DRAWINGS

A complete understanding of the present invention may be obtained by reference to the accompanying drawings when considered in conjunction with the following detailed description, in which:

FIG. 1(A) is an illustration of the leading edge of a liquid distributor and FIG. 1(B) is an illustration of the trailing edge of a liquid distributor in accordance with an embodiment of the present invention.

FIG. 2 is a cross sectional view of a liquid distributor in accordance with another embodiment of the present invention.

FIG. 3 is a cross sectional view of a liquid distributor in accordance with another embodiment of the present invention.

FIG. 4 is a schematic illustration of a hydrogen generator system in accordance with an embodiment of the present invention with a liquid reagent storage area, a liquid distributor, and a reaction chamber.

FIG. 5 is a schematic illustration of a hydrogen generator system in accordance with an embodiment of the present invention with a liquid reagent storage area comprising an inner chamber, a liquid distributor, and a reaction chamber.

FIG. 6 is a schematic illustration of a hydrogen generator system in accordance with another embodiment of the present invention with a liquid reagent storage area comprising an inner chamber, a liquid distributor, and a reaction chamber.

FIG. 7 is a schematic illustration of a hydrogen generator system in accordance with another embodiment of the present invention with a liquid reagent storage area comprising an inner chamber, a liquid distributor, and a reaction chamber.

FIG. 8 is a schematic illustration of a radial liquid distributor hydrogen generator system in accordance with an embodiment of the present invention with a liquid reagent storage area, a liquid distributor, and a reaction chamber.

FIG. 9 is an illustration of a hydrogen generator in accordance with an embodiment of the present invention with a liquid reagent storage area, a liquid distributor, and a reaction chamber enclosed in an outer housing.

FIG. 10 is an illustration of an inner wall of hydrogen generator in accordance with an embodiment of the present invention.

FIG. 11 is an illustration of a further embodiment of the invention.

### DETAILED DESCRIPTION OF THE INVENTION

The present invention provides methods and apparatus for contacting a chemical hydride fuel with an aqueous reagent to generate hydrogen gas and nongaseous products.

The invention provides systems and methods for hydrogen generation by the hydrolysis of a solid fuel. In a preferred embodiment, the system includes a liquid reagent storage region, a reaction chamber adapted to contain at least one solid fuel capable of generating hydrogen upon contact with the liquid reagent, and a liquid distributor disposed in the reaction chamber for contacting the solid fuel with the liquid reagent in the reaction chamber to produce hydrogen gas and a substantially fluid nongaseous product.

In another embodiment, apparatus are provided for hydrogen generation by the hydrolysis of a solid fuel including a storage area adapted to contain a liquid reagent, a reaction chamber adapted to contain a solid fuel capable of generating hydrogen upon contact with the liquid reagent, the storage area bounded by at least one moveable wall, and a liquid distributor disposed in the reaction chamber for contacting the solid fuel with the liquid reagent in the reaction chamber to produce hydrogen gas and a substantially fluid nongaseous product.

The present invention further provides methods of generating hydrogen gas by a hydrolysis reaction utilizing a solid fuel capable of generating hydrogen and a substantially fluid nongaseous product when contacted with a liquid reagent. A liquid reagent is provided, and the liquid reagent and the solid fuel are contacted in a reaction chamber in which a liquid distributor is disposed, wherein such contact generates hydrogen gas and a substantially fluid nongaseous product, and the liquid distributor is configured to move through the substantially fluid nongaseous product.

In one embodiment, the present invention provides methods of generating hydrogen gas by a hydrolysis reaction utilizing a solid fuel capable of generating hydrogen and a substantially fluid nongaseous product when contacted with a liquid reagent. A liquid reagent is provided, and the liquid reagent and the solid fuel are contacted in a reaction chamber bounded by at least one hydrogen separator and in which a liquid distributor is disposed, wherein such contact generates hydrogen gas and a substantially fluid nongaseous product and movement of the liquid distributor in the reaction chamber exposes additional hydrogen separators.

In another embodiment, the present invention provides methods of operating a power module, by providing a power module having a hydrogen gas inlet in communication with a hydrogen gas outlet of an associated hydrogen generator. A solid fuel capable of generating hydrogen and a substantially fluid nongaseous product when contacted with a liquid reagent is provided. A liquid reagent is provided, and the liquid reagent and the solid fuel are contacted in a reaction chamber in which a liquid distributor is disposed, wherein such contact generates hydrogen gas and a substantially fluid nongaseous product. In a preferred embodiment, water generated as a product in a fuel cell power module is transported back to the liquid reagent storage chamber of the hydrogen generator.

As used herein, the term “nongaseous” comprises solid and liquid forms; the nongaseous products may be a mixture of solid and liquid materials and may comprise a metal salt product.

The preferred chemical hydride fuel components for the present invention are chemical hydrides in solid form. These chemical hydrides may be utilized in mixtures, but are preferably utilized individually. The term chemical hydrides as used herein includes the alkali and alkaline earth metal hydrides and boron hydrides; these compounds react with water to produce hydrogen gas and a metal salt, the nature and composition of which depends on the nature of chemical hydride.

The term “solid form” encompasses any dry or substantially dry form, including powder, granules, monoliths, or pellets.

The alkali and alkaline earth metal hydrides have the general formula MHₙ wherein M is a cation selected from the group consisting of alkali metal cations such as sodium, potassium or lithium and alkaline earth metal cations such as calcium, and n is equal to the charge of the cation. Examples of suitable metal hydrides, without intended limitation, include NaH, LiH, MgH₂, and the like. The alkali and alkaline earth metal hydrides typically produce metal hydroxide salts and hydrogen gas when hydrolyzed, for example, the reaction of sodium hydride with water produces hydrogen gas and sodium hydroxide, though the products are not limited to metal hydroxide salts.

The terms “boron hydride” or “boron hydrides” as used herein include boranes, polyhedral boranes, and anions of borohydrides or polyhedral boranes, such as those provided in co-pending U.S. patent application Ser. No. 10/741,199, entitled “Fuel Blends for Hydrogen Generators,” filed Dec. 19, 2003 (U.S. Pat. Publ. No. 2005/0132640), the entire disclosure of which is hereby incorporated herein. Suitable boron hydrides include, without intended limitation, the group of borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, among others, where M is a cation selected from the group consisting of alkali metal cations, alkaline earth metal cations, aluminum cation, zinc cation, and ammonium cation, and n is equal to the charge of the cation; and neutral borane compounds, such as decaborane(14) (B₁₀H₁₄); ammonia borane compounds of formula NHₓBH_{y}, wherein x and y independently=1 to 4 and do not have to be the same, of formula NHₓRBH_{y}, wherein x and y independently=1 to 4 and do not have to be the same, and R is a methyl or ethyl group, and of formula NH₃B₃H₇, and dimethylamine borane (NH(CH₃)₂BH₃). For the above-mentioned boron hydrides, M is preferably sodium, potassium, lithium, or calcium. The boron hydrides typically produce a boron-oxygen salt and hydrogen gas when hydrolyzed. For example, the reaction of an alkali metal borohydride with water as shown in Equation (1) produces a hydrated alkali metal metaborate which may be represented by formula MBO₂.nH₂O, though other products may be produced. For sodium borohydride (NaBH₄), n preferably is 2; however, n is variable and is determined by the temperature and the borohydride salt, among other factors.

The chemical hydride may be anhydrous or hydrated and preferably contains less than about 50 wt % water. The hydrated forms of certain borohydride salts, notably sodium borohydride, exist at low to moderate temperatures. For example, sodium borohydride dihydrate (NaBH₄.2H₂O, 51.2 wt % NaBH₄ and 48.8 wt % H₂O) is formed at temperatures below 36.4° C., potassium borohydride trihydrate exists at temperatures below 7.5° C., and potassium borohydride monohydrate exists at temperatures below 37.5° C.

A metal borohydride fuel component may be combined with a solid stabilizer agent, preferably one selected from the group consisting of metal hydroxides, anhydrous metal metaborates, hydrated metal metaborates, and mixtures thereof. Solid stabilized fuel compositions comprising about 20 to 99.7 wt-% borohydride and 0.3 to 80 wt-% hydroxide salts are disclosed in co-pending U.S. patent application Ser. No. 11/068,838 entitled “Borohydride Fuel Composition and Methods” filed on Mar. 1, 2005, the disclosure of which is incorporated by reference herein in its entirety.

The aqueous reagent may be water or may comprise a soluble reagent in an aqueous solution. The aqueous reagent may be an aqueous acidic solution, i.e., a reagent having a pH less than about 7. Suitable acidic solutions include, but are not limited to, inorganic acids such as the mineral acids hydrochloric acid (HCl), sulfuric acid (H₂SO₄), and phosphoric acid (H₃PO₄), and organic acids such as acetic acid (CH₃COOH), formic acid (HCOOH), malic acid, maleic acid, citric acid, and tartaric acid, among others. The acidic reagents may also comprise a combination of organic and/or inorganic acids. Different acids have different characteristics such as solution density and viscosity so the choice of acid may be different for various applications. Preferably, the liquid reagent is a solution containing the acidic reagent in a range from about 0.1 to about 40 wt %. In some embodiments, the liquid reagent is an aqueous solution with a water concentration in the range of about 44 to about 52 molar (M) water, preferably about 46 to about 50 M water and most preferably about 48 M water (in comparison, pure water can be considered to have a water concentration of about 55 M water) and has a pH less than 7. Higher reagent concentrations may be stored through the use of water recaptured from hydrogen consumption devices, such as fuel cells. For instance, if about 50% of the water exhausted at the cathode of a fuel cell were recovered the concentration of acid might be increased by about 25%, depending on fuel cell efficiency and acid concentration.

The liquid reagent may be a transition metal solution, i.e., a solution containing a water soluble transition metal salt, for example, the chloride salts of cobalt (COCl₂), nickel (NiCl₂), or copper (CuCl₂). In such cases, as the reagent solution contacts the borohydride, the metal ion is typically reduced by the borohydride and deposited as metal particles or metal boride compounds in the solid borohydride contained within the reaction chamber, and accumulate in the reaction chamber as the borohydride is consumed. Since these materials can also catalyze hydrolysis of borohydride, the increased concentration of metal catalyst with increased time of operation ensures that the borohydride fuel is completely converted to hydrogen. Alternatively, the hydrogen generator may operate by initially feeding a transition metal solution to the borohydride fuel to accumulate metal particles or metal boride compounds in the solid fuel, and then feeding only water or an acidic reagent to the borohydride fuel to react with the remaining fuel.

In hydrogen generation systems in accordance with embodiments of the present invention, hydrogen is produced by contacting a solid chemical hydride fuel with a liquid reagent to transform the chemical hydride fuel into hydrogen gas and an oxidized product which is typically a metal salt or oxide compound (“product” or “discharged fuel”). The rate of hydrogen generation can be regulated by controlling the contact between the liquid reagent and the solid chemical hydride. The hydrogen generation reaction can be stopped by preventing contact between the liquid reagent and the solid chemical hydride.

Preferred embodiments of the present invention provide hydrogen generation systems in which a liquid reagent distributor is disposed within a reaction chamber containing the chemical hydride compound in solid form. For the method of the present invention, it is preferred that the product produced by the contact of the liquid reagent and solid chemical hydride be substantially fluid. In this context, the term “substantially fluid” means a product or products in a liquid or slurry state at least temporarily such that the product or products produced can pass through channels in the liquid reagent distributor to a “trailing” edge, i.e., the side opposite or distal to unreacted solid fuel, and facilitate the movement of the liquid reagent distributor through the remaining unreacted fuel; the product does not need to remain fluid after passage through the channels, and may solidify over time. In this manner, the leading surface of the liquid reagent distributor is exposed to unreacted fuel.

Preferably, the hydrogen generation systems allow volume exchange such that the products can occupy the space originally occupied by the solid chemical hydride and/or liquid reagent.

The state of discharged fuel and distribution of products can be controlled by the selection of particular liquid reagents, reagent concentration, and the ratio of liquid reagent to solid chemical hydride, for example, as shown in Table 1 for the reaction of hydrochloric acid with a mixture comprising about 87 wt-% sodium borohydride and about 13 wt-% sodium hydroxide.

TABLE 1
Hydrogen generation from about 87/13 wt/wt NaBH₄/NaOH

| Concentration | Weight ratio | Molar ratio | | | | |
|---|---|---|---|---|---|---|
| (wt % HCl) | Acid:NaBH₄ | H₂O:NaBH₄ | H⁺:NaBH₄ | Conversion (%) | State | Bulk Density (g/mL) |
| 15 | 2.6 | 5.27 | 0.46 | 100 | slurry | 0.78 |
| 20 | 3.0 | 5.09 | 0.64 | 100 | slurry | 1.60 |
| 22 | 2.6 | 4.9 | 0.70 | 95 | solid | 1.08 |

Additionally, controlling the temperature at the reaction site and of the byproduct will affect the hydration and physical state of the product. For example, the hydrolysis of sodium borohydride with water yields a mixture of sodium metaborate hydrates, including the tetrahydrate (4 waters per boron on a molar basis), the dihydrate (2 waters per boron on a molar basis), and the hemihydrate (0.5 waters per boron on a molar basis). At temperatures around about 53° C., the tetrahydrate will melt in its waters of hydration producing a fluid product.

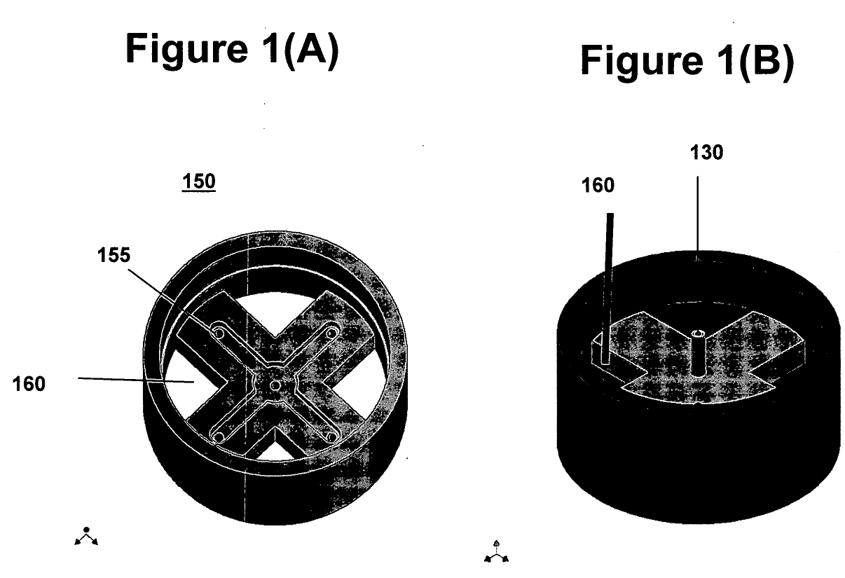

Exemplary embodiments of liquid reagent distributors useful in embodiments of the present invention are illustrated in FIGS. 1, 2 and 3, wherein features that are similar have like numbering.

FIG. 1(A) illustrates the leading edge and FIG. 1(B) illustrates the trailing edge of a liquid distributor useful in embodiments of the invention. A liquid distributor 150 comprises at least one inlet 130 and at least one outlet 155 for distribution of the liquid reagent to the chemical hydride fuel, and channels 160 to allow the substantially fluid products to pass through the liquid distributor. The number, position, and size of outlets 155 and channels 160 are variable, and are not limited to the orientation shown in FIG. 1. The substantially fluid product in a liquid or slurry form passes through the channels 160 in the liquid distributor 150 to the “trailing” side of the liquid distributor, i.e., the side opposite or distal to the solid fuel. In this manner, the leading surface of the liquid distributor is always exposed to unreacted fuel and the products move out of the way to the trailing surface of the liquid distributor.

The surface of the liquid distributor adjacent to outlets 155 may comprise a metal that promotes the hydrolysis of a chemical hydride. Suitable transition metal catalysts for the generation of hydrogen from a metal hydride solution include metals from Group IB to Group VIIIB of the Periodic Table, either utilized individually or in mixtures, or as compounds of these metals. Representative examples of these metals include, without intended limitation, transition metals represented by the copper group, zinc group, scandium group, titanium group, vanadium group, chromium group, manganese group, iron group, cobalt group and nickel group, among others. Examples of useful catalyst metals include, without intended limitation, ruthenium, iron, cobalt, nickel, copper, manganese, rhodium, rhenium, platinum, palladium, and chromium, for example, used individually or as mixtures. The preparation of supported catalysts is taught, for example, in U.S. Pat. No. 6,534,033 entitled “System for Hydrogen Generation,” wherein the catalyst metal is deposited on, or bound to, a support structure.

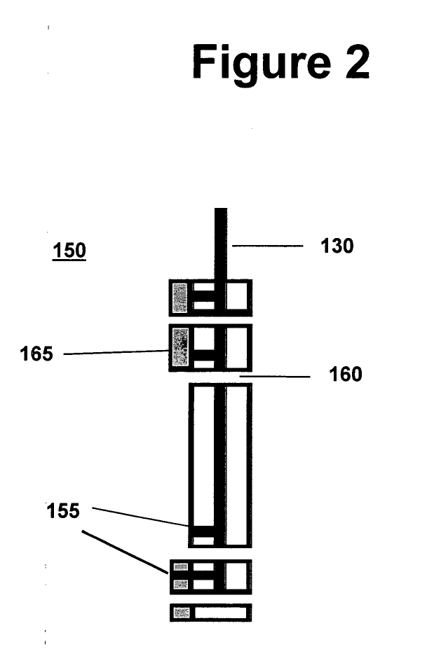

Referring now to FIG. 2, an exemplary liquid distributor 150 coated with a metal catalyst 165 can be described as a “supported catalyst.” Outlets 155 can pass through the metal catalyst 165 layered on the surface of the liquid distributor 150. Alternatively, the catalyst layer 165 may be porous and outlets 155 may terminate before the layer such that the reagent can pass in contact with the catalyst. Both configurations are shown in FIG. 2.

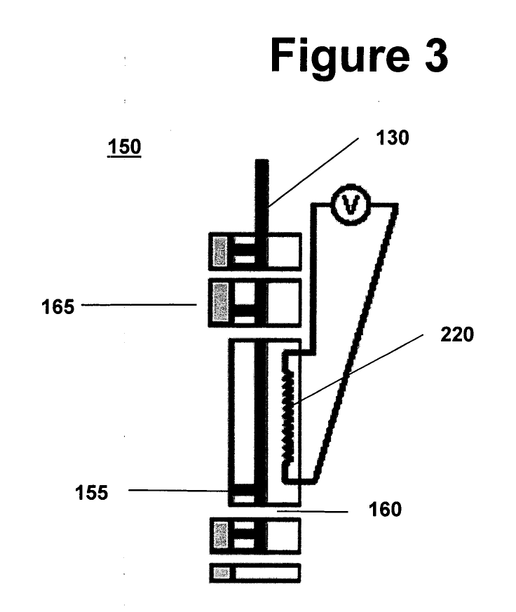

The liquid distributor 150 may further comprise a heating element that may be run continuously or intermittently to accelerate the rate of hydrolysis or maintain the products in a substantially liquid state, for example. The heating element may provide for increased efficiency in system startup. FIG. 3 illustrates an exemplary liquid distributor 150 coated with a metal catalyst 165 and incorporating a resistive heating coil 220. The liquid distributor 150 may comprise one or both of the heater 220 and the supported metal catalyst 165.

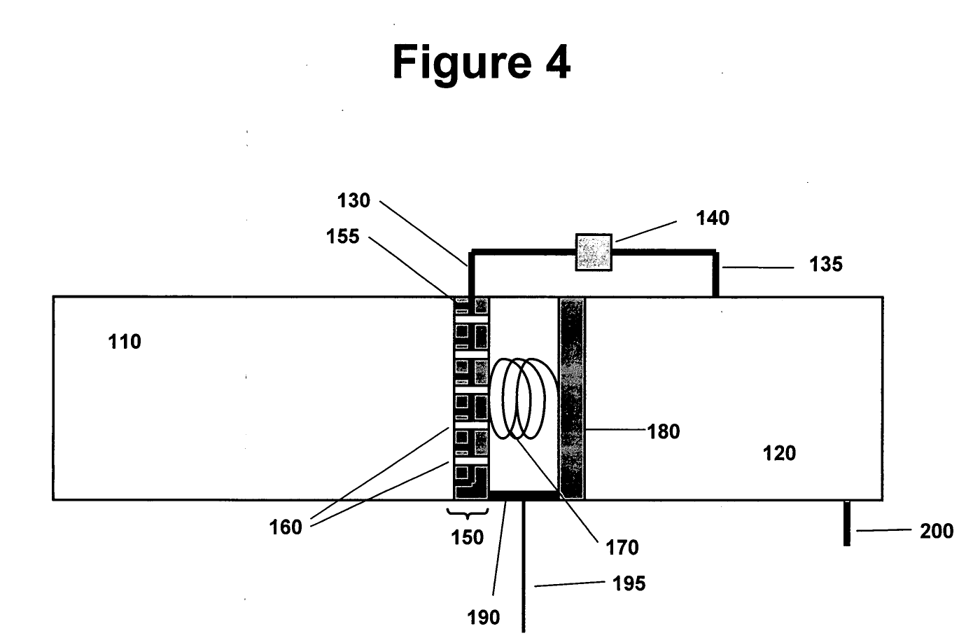

Referring now to FIG. 4, an exemplary generator to produce hydrogen from the hydrolysis of solid hydride fuel suitable for use with a liquid distributor in accordance with an embodiment of the invention comprises a reaction chamber 110 and a liquid reagent storage chamber 120. The reaction chamber 110 and the liquid reagent storage chamber 120 may be separated from each other by a wall 180, which may be rigid or flexible, and moveable or fixed in place. A liquid reagent conduit 135 in fluid communication with inlet 130 of the liquid distributor and a liquid reagent regulator 140 allow the liquid reagent to be transported from the liquid reagent storage chamber 120 to the reaction chamber 110.

Reaction chamber 110 comprises a liquid distributor 150 disposed axially therein, an actuator 170, and a hydrogen outlet 195. The hydrogen generator may be a single discrete unit or may be comprised of separable components; for instance, the reaction chamber 110 may be removably attached to the liquid reagent storage chamber 120, and thus one or both of these compartments are refillable or replaceable.

Liquid reagent regulator 140 may comprise, for example, a pump including, but not limited to, a peristaltic pump, a piezoelectric pump, a piston pump, a diaphragm pump, a centrifugal pump, or an axial flow pump; or a valve including, but not limited to, a solenoid valve, a ball valve, a pinch valve, or a diaphragm valve.

Hydrogen outlet line 195 connects reaction chamber 110 to a power module comprising a fuel cell or hydrogen-burning engine for conversion to energy, or to a hydrogen storage device, such as a balloon, a gas cylinder or a metal hydride. A hydrogen separator 190 is arranged such that the hydrogen generated in the reaction chamber passes through the separator 190 to separate the hydrogen gas from the solids and liquids within the reaction chamber 110 before the hydrogen gas is removed via the hydrogen outlet line 195. The separator is preferably in communication with hydrogen outlet line 195, and can be incorporated at the inlet. The separator may be a gas permeable membrane or filter that is preferably substantially impermeable to liquids and solids. “Substantially impermeable” in this context means preferentially allowing passage of gases relative to the passage of solids and/or liquids or, in preferred cases, allowing passage only of gases. Examples of suitable gas permeable membranes include materials that are more permeable to hydrogen than to a liquid such as water, for example, silicon rubber, polyethylene, polypropylene, polyurethane, fluoropolymers or any hydrogen-permeable metal membranes such as palladium-gold alloys. The gas permeable membrane is preferably microporous and hydrophobic.

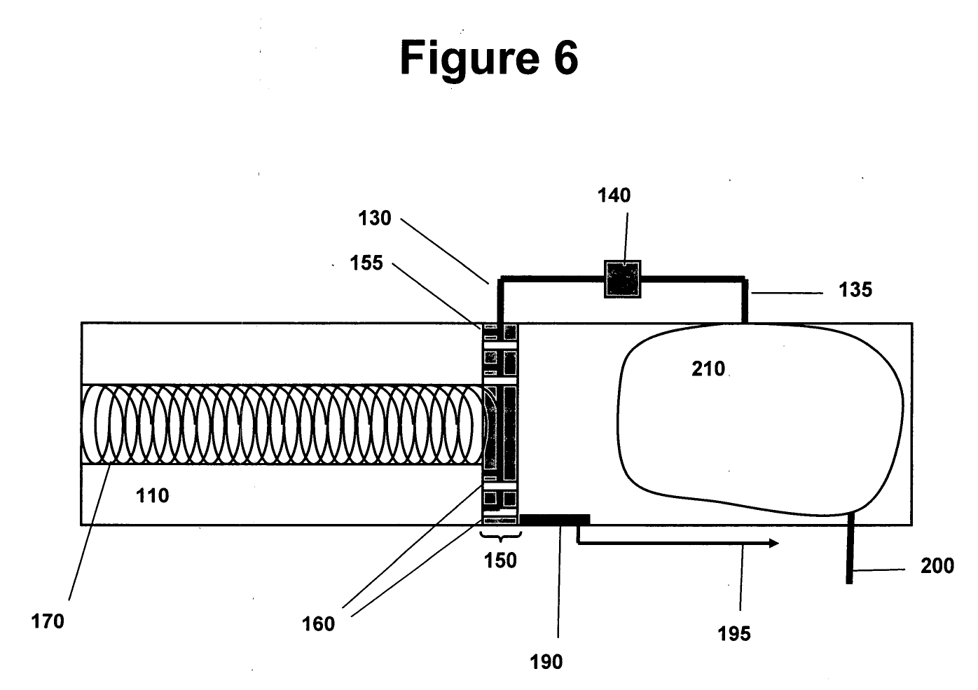

The actuator 170 provides mechanical energy to move the liquid distributor 150. Actuators suitable for use in embodiments of the invention include mechanical springs, air springs, magnetic drives, and screw drives. Preferably, the actuator is a mechanical spring that moves the liquid distributor 150 by either being expanded or compressed beyond its relaxed, neutral state. Nonlimiting examples of useful springs include tension/extension springs, compression springs, helical springs, and coil springs. In some configurations, the spring will be extended during operation, and will “push” the liquid distributor through the reaction chamber 110 as provided in FIG. 4. In other configurations, the spring will be compressed during operation, for instance, as illustrated in FIG. 6, and the spring will “pull” the liquid distributor through the reaction chamber 110.

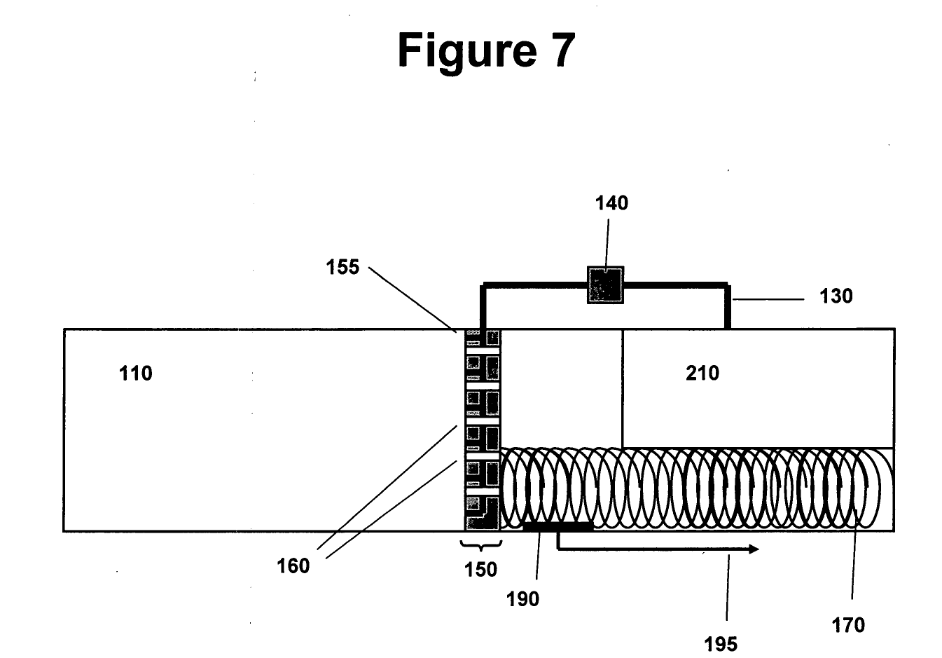

The actuator may be used to provide unilateral movement such that only the liquid distributor 150 moves; in such cases it would be attached to a fixed, i.e., non-moveable, wall. In these cases, wall 180 (as in FIG. 4) or a wall of the outer housing located either in the reaction chamber 110 (as in FIG. 6) or in the liquid reagent chamber 120 (FIG. 7) could function as a non-moving fixed wall.

Alternatively, the actuator 170 may exert a pressure on both the liquid distributor 150 and the wall 180, or separate actuators may be used for movement of liquid distributor 150 and the wall 180. Preferably, the liquid reagent contained within chamber 120 occupies a finite volume, that is, it is incompressible, and wall 180 cannot move until the regulator 140 operates, that is, a valve is opened or a pump is turned on. In such a design wherein both the liquid distributor 150 moves through the reaction chamber and the wall 180 moves to diminish the volume of the liquid storage chamber 120, the relative movements do not need to be symmetric. That is, one or the other of wall 180 and liquid distributor 150 may move a greater linear distance from its respective origin than the other.

An optional inlet 200 may be included to allow water generated by the hydrogen fuel cell or collected from a condenser or dehumidifier elsewhere within the power system to be passed into the liquid reagent reservoir 120 to be contained within either the reservoir 120 or an inner container. This allows the water to be collected as it is generated.

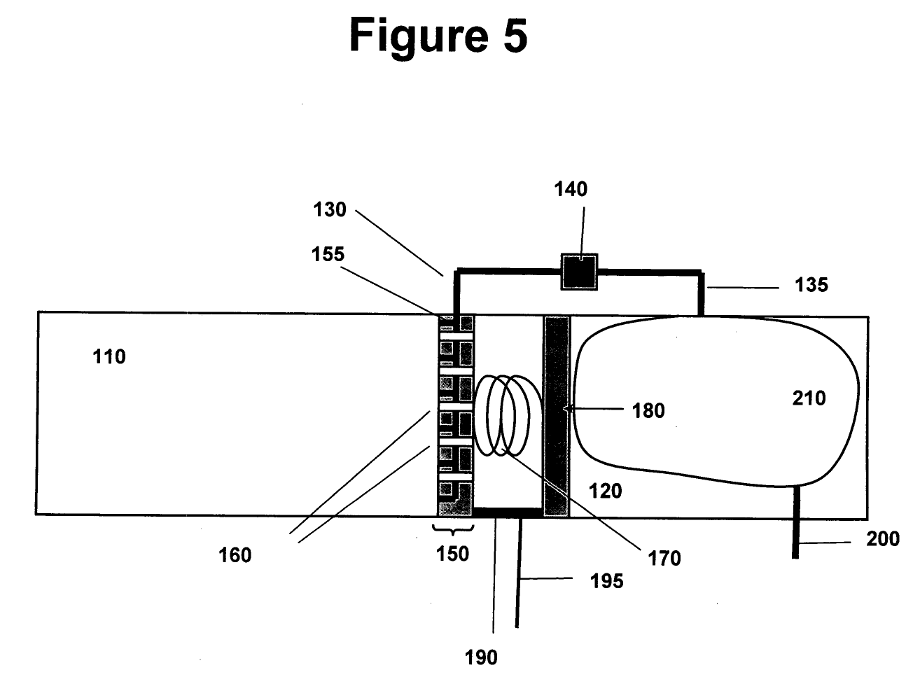

As illustrated in FIG. 5, wherein features that are similar to those shown in previous figures have like numbering, the aqueous reagent may be stored in an inner container 210 which may be rigid or flexible. Preferably, inner container 210 is flexible to enable volume exchange between chambers 110 and 120 and to accommodate the products as they pass through the liquid distributor 150 within the reaction chamber 110. Suitable liquid-tight materials for the inner container 210 include, but are not limited to, nylon; polyurethane; polyvinylchloride (PVC); polyethylene polymers, including such as low density polyethylene (LDPE), linear low density polyethylene (LLDPE), high density polyethylene (HDPE), and ethylene-vinyl acetate copolymers (EVA); natural rubber; synthetic rubber; and metal foil. In some aspects of the invention wherein an inner container 210 is utilized, the inner wall 180 may be omitted as illustrated in FIGS. 6 and 7.

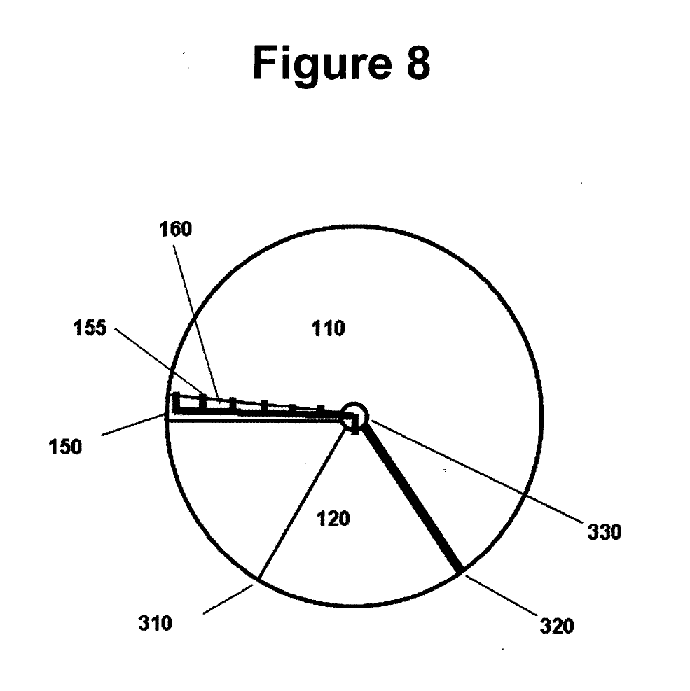

Referring now to FIG. 8, wherein features that are similar to those shown in previous figures have like numbering, an exemplary radial liquid distributor generator to produce hydrogen from the hydrolysis of solid hydride fuel comprises a reaction chamber 110, a liquid reagent storage chamber 120, a liquid distributor 150, a first wall 310, a second wall 320, and an actuator 330. A radial liquid distributor hydrogen generator may further comprise a liquid reagent conduit 135, a liquid reagent regulator 140, a hydrogen separator 190, and a hydrogen outlet 195, which are not shown in FIG. 8.

The actuator 330 is preferably a twisted spring, or a rotary spring. The walls 310 and 320 may independently be flexible or rigid. One or both of first wall 310 and second wall 320 may comprise a rotary sliding wall, for example, with a sliding gasket seal against the outer wall.

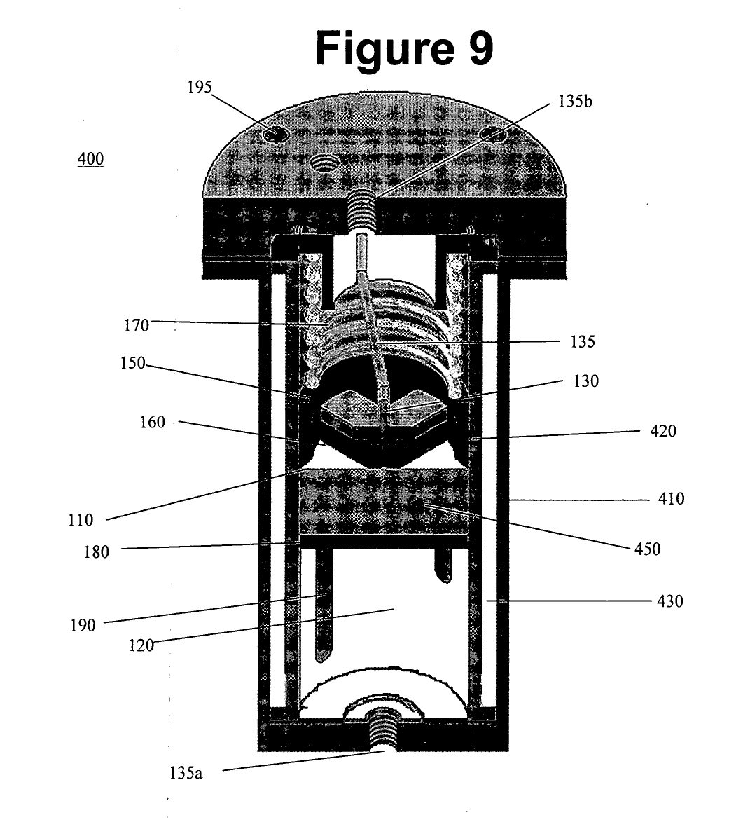

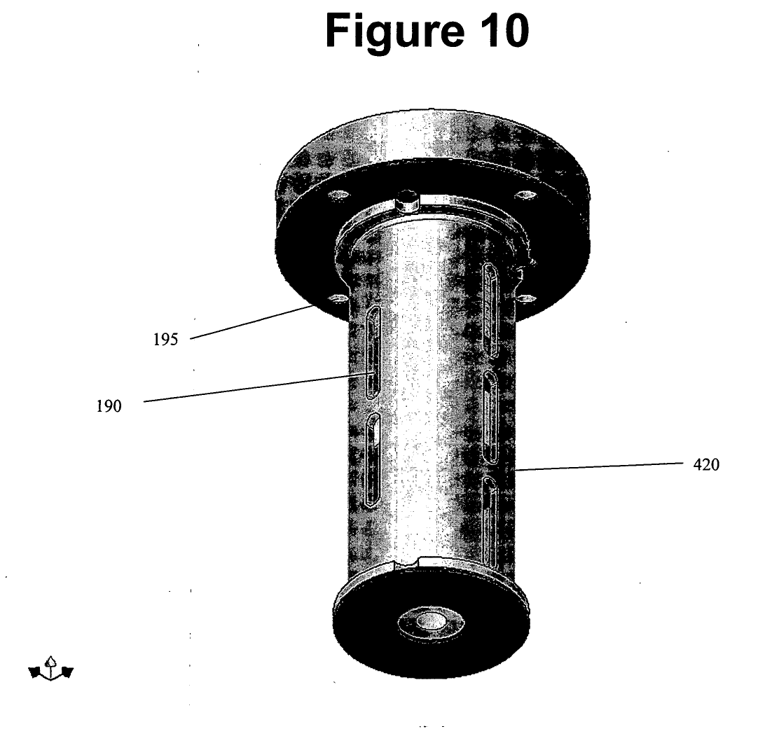

In reference to FIGS. 9 and 10, the hydrogen generation system can be packaged as a fuel cartridge 400 comprising a liquid reagent storage chamber 120 containing a liquid reagent and a reaction chamber 110 containing a solid chemical hydride fuel 450 separated by a moveable wall 180 wherein a liquid distributor 150 and an actuator 170 are disposed within the reaction chamber. One of both of a liquid reagent conduit 135 and a liquid reagent regulator 140 may be packaged within the fuel cartridge, or may be external to a replaceable fuel cartridge and be located, for example, with a fuel cell power module.

The liquid reagent regulator 140 may comprise a separable pump wherein a pump head resides in one of the fuel cartridge or fuel cell power module and a controller resides in the other of the fuel cartridge or fuel cell power module. The controller comprises a motor or an electrical contact. In general, peristaltic and piston pumps operate through the use of a pump head comprised of a series of fingers in a linear or circular configuration or at least one piston which can compress the fuel line; the fingers may be in a variety of configurations and alternatively referred to as rollers, shoes, or wipers. The compression of the fuel line by the fingers forces the liquid through the line; when the line is not compressed and open, fluid flows into the fuel line. A diaphragm pump configuration comprises a diaphragm in the wall of fuel line, check valves on the upstream and downstream sides of the diaphragm, and a pump head. In general, diaphragm pumps operate through the use of a pump head comprised of a series of cams in a linear or circular configuration or at least one piston which can compress the diaphragm; the compression of the membrane by the fingers forces the liquid through the line; when the membrane expands and is not compressed, fluid is drawn into the fuel line. The cams may be in a variety of configurations and alternatively referred to as rollers, shoes, or wipers. The check valves constrain and control the directional flow through the diaphragm and fuel line.

The liquid reagent stored within chamber 120 is compressed by a wall 180. In this embodiment, the wall 180 moves in response to movement of the liquid distributor 150 and actuator 170. This wall 180 cannot move without operating a liquid reagent regulator, e.g., a valve is opened or a pump is turned on. Suitable liquid reagent regulators include, but are not limited to, peristaltic pumps, piezoelectric pumps, piston pumps, diaphragm pumps, centrifugal pumps, axial flow pumps, solenoid valves, ball valves, pinch valves, and diaphragm valves.

The chamber 110, liquid distributor 150, actuator 170, and liquid reagent chamber 120 may be contained within an inner housing 420 and an outer housing 410. The region bounded by the inner housing 420 and the outer housing 410 forms a gas ballast region 430. During startup of the hydrogen generation system, the gas ballast region 430 can provide stored hydrogen to supply the demand of the power module or other hydrogen device prior to onset of hydrogen generation. This ballast hydrogen may comprise hydrogen generated from residual fuel components after the liquid reagent feed is stopped or hydrogen previously unconsumed by the hydrogen device. Hydrogen is fed to the hydrogen device from one or more hydrogen outlets 195.

At least one hydrogen separator 190 is present in the wall of inner housing 420, and may be located at any position along the length of the generator. Preferably, at least a portion of at least one hydrogen separator 190 is located on the distal side of the liquid distributor and at least a portion of at least one hydrogen separator 190 is located on the proximal side of the liquid distributor. In some configurations, a single separator 190 may be present; in other configurations, a plurality of separators 190 are present. The size of the generator, intended use, and available surface area of inner housing 420 will determine the appropriate number of separators.

Referring to FIGS. 9 and 10, a method for generating hydrogen using a generator as described herein comprises conveying a liquid reagent from a storage chamber 120 through conduit 135 using a liquid reagent regulator (not illustrated) to a reaction chamber 110 containing a solid chemical hydride fuel 450, which may be a compacted mixture, powder or granules. Preferably the liquid reagent is an acidic reagent comprised of hydrochloric acid, phosphoric acid, or sulfuric acid.

The liquid reagent is fed from storage chamber 120 though outlet 135a which is connected via conduit 135 (the external portion of this conduit is not illustrated in FIG. 9) to inlet 135b and delivered to the leading surface of the liquid distributor 150, i.e., the side adjacent or proximal to the solid fuel 450 in reaction chamber 110, whereupon it reacts with the fuel to create hydrogen gas and a product. The product is substantially fluid in a liquid or slurry form, at least initially or temporarily, to allow the substantially fluid product to pass through the channels 160 in the liquid distributor 150 to the “trailing” side of the liquid distributor, i.e., the side opposite or distal to the solid fuel, and facilitate the movement of the liquid distributor 150 through the remaining unreacted fuel. Hydrogen passes through at least one hydrogen separator 190 present in the wall of inner housing 420 to gas ballast region 430, and can be fed to the hydrogen device from one or more hydrogen outlets 195.

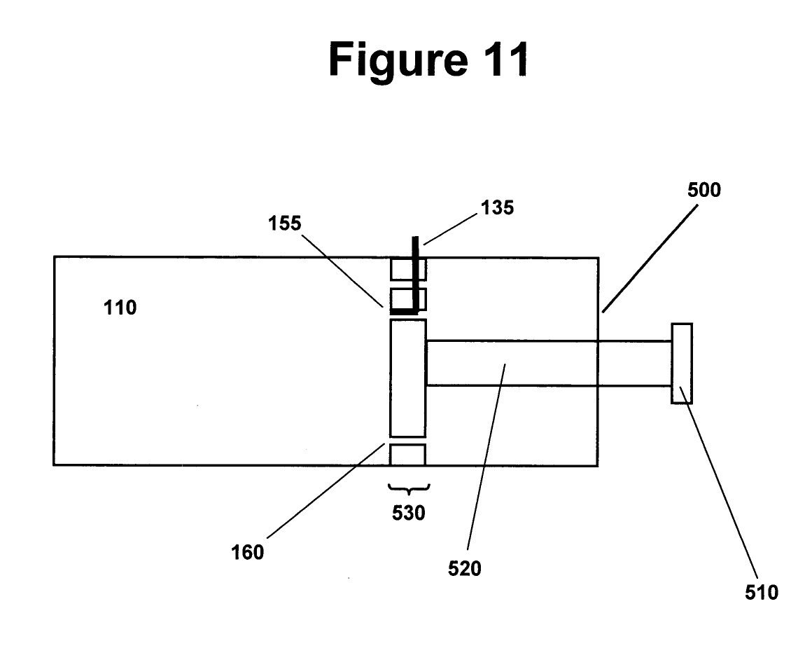

An embodiment of the invention as shown in FIG. 11 was tested experimentally using a solid chemical hydride fuel comprised of a mixture of sodium borohydride and sodium hydroxide (about 87 wt % sodium borohydride and about 13 wt % sodium hydroxide) compressed to a solid mixture under about 500 pounds of applied load in a hydraulic press to a density of about 0.80 g/cm³. A 25 cc syringe barrel comprised the reaction chamber 110 and the syringe plunger 500 was modified to act as the liquid distributor and the actuator. Channels 160 were drilled through the tip 530 of the syringe plunger; the combination of shaft 520 and handle 510 were used to provide movement of the tip. A liquid reagent feed tube 135 terminating in an outlet 155 was inserted through one of the channels 160. Upon delivery of about 27 wt-% H₂SO₄ solution to the leading edge of the tip 530 facing the solid fuel, the solid fuel reacted with the acid to produce hydrogen and a substantially fluid product which passed through the channels 160 to the trailing edge. Moderate pressure was applied to the syringe plunger initially by hand, and after about 5 minutes by a clamp.

While the present invention has been described with respect to particular disclosed embodiments, it should be understood that numerous other embodiments are within the scope of the present invention. Accordingly, it is not intended that the present invention be limited to the illustrated embodiments, but only by the appended claims.

What is claimed as new and desired to be protected by Letters Patent of the United States is:

1. A hydrogen gas generating system, comprising:
a reaction chamber configured to contain a solid chemical hydride;
a liquid distributor disposed within said reaction chamber, wherein said liquid distributor comprises at least one channel, at least one inlet, and at least one outlet;
an actuator configured to move the liquid distributor relative to the reaction chamber;
at least one liquid reagent storage chamber for containing an aqueous reagent;
a liquid reagent conduit line for conveying the aqueous reagent from the at least one liquid reagent storage chamber to the liquid distributor;
a liquid reagent regulator; and
a hydrogen gas outlet,
wherein reaction of said chemical hydride and said aqueous reagent generates hydrogen and a substantially fluid nongaseous product, and said liquid distributor is configured to allow the substantially fluid nongaseous product to pass through the at least one channel.

2. The hydrogen gas generating system of claim 1, wherein the reaction chamber and the liquid reagent storage chamber are arranged in a volume exchanging configuration.

3. The hydrogen gas generating system of claim 1, wherein said liquid reagent storage chamber comprises an inner container.

4. The hydrogen gas generating system of claim 1, further comprising a movable or flexible wall separating said reaction chamber and said liquid reagent storage chamber.

5. The hydrogen gas generating system of claim 1, further comprising at least one gas permeable membrane in contact with the reaction chamber, wherein the membrane is configured to allow hydrogen to pass through the membrane while preventing solid and liquid materials from passing through the membrane.

6. The hydrogen gas generating system of claim 5, wherein at least a portion of the at least one gas permeable membrane is exposed in the reaction chamber by movement of the liquid distributor.

7. The hydrogen gas generating system of claim 1, wherein said liquid distributor further comprises a heating element.

8. The hydrogen gas generating system of claim 1, wherein said liquid distributor further comprises a catalyst layer.

9. The hydrogen gas generating system of claim 1, wherein said liquid distributor is axially disposed within the reaction chamber.

10. The hydrogen gas generating system of claim 1, wherein said liquid distributor is radially disposed within the reaction chamber.

11. The hydrogen gas generating system of claim 1, wherein said chemical hydride is a boron hydride.

12. The hydrogen gas generating system of claim 1, wherein said aqueous reagent is water or an acidic solution.

13. A hydrogen fuel cartridge, comprising:
a reaction chamber and a liquid fuel storage chamber contained within an inner housing, wherein said reaction chamber and said liquid fuel storage chamber are arranged in a volume exchanging configuration;
a liquid distributor disposed within said reaction chamber;
an actuator configured to move the liquid distributor relative to the reaction chamber;
at least one hydrogen separator present in a wall of said inner housing;
a gas storage region; and
a hydrogen outlet.

14. The hydrogen fuel cartridge of claim 13 further comprising a liquid reagent regulator selected from the group consisting of a peristaltic pump, a piezoelectric pump, a piston pump, a diaphragm pump, a centrifugal pump, and an axial flow pump.

15. The hydrogen fuel cartridge of claim 13 further comprising a liquid reagent regulator selected from the group consisting of a solenoid valve, a ball valve, a pinch valve, and a diaphragm valve.

16. The hydrogen fuel cartridge of claim 13., wherein said inner housing is contained within an outer housing, and the space between the inner housing and the outer housing comprises the gas storage region.

17. A method of generating hydrogen, comprising:
providing a solid chemical hydride in a reaction chamber;
providing an aqueous reagent;
providing a liquid distributor comprising a plurality of channels in said reaction chamber;
contacting the liquid reagent with the chemical hydride in the reaction chamber to produce hydrogen gas and a substantially fluid nongaseous product; and
moving the liquid distributor through at least a portion of the substantially fluid nongaseous product.

18. The method of generating hydrogen of claim 17, wherein said chemical hydride is a boron hydride.

19. The method of generating hydrogen of claim 18, wherein said boron hydride is an alkali metal borohydride.

20. The method of generating hydrogen of claim 18, wherein said boron hydride is selected from the group of ammonia borane compounds consisting of NH₃BH₃ and NH₃B₃H₇.

21. The method of generating hydrogen of claim 17, wherein said aqueous reagent is water or an acidic solution.

22. The method of generating hydrogen of claim 21, wherein said aqueous reagent is an acidic solution selected from the group consisting of solutions of hydrochloric acid, sulfuric acid, and phosphoric acid.

23. The method of generating hydrogen of claim 21, wherein said aqueous reagent is an acidic solution selected from the group consisting of solutions of formic acid, acetic acid, citric acid, malic acid, and maleic acid.

24. The method of generating hydrogen of claim 17, further comprising transporting said hydrogen to a hydrogen device selected from the group consisting of a fuel cell, a hydrogen-burning engine, and a hydrogen storage device.

25. The method of generating hydrogen of claim 17, further comprising transporting water from the fuel cell to either the reaction chamber or to a chamber storing the aqueous reagent.
